(19) United States
(12) Patent Application Publication
(10) Pub. No.: US 2017/0021821 A1
(43) Pub. Date: Jan. 26, 2017

(54) HYBRID VEHICLE CONTROL APPARATUS

(71) Applicant: TOYOTA JIDOSHA KABUSHIKI KAISHA, Toyota-shi (JP)

(72) Inventors: Yuki OGAWA, Toyota-shi (JP); Mitsuharu KATO, Kasugai-shi (JP)

(73) Assignee: TOYOTA JIDOSHA KABUSHIKI KAISHA, Toyota-shi (JP)

(21) Appl. No.: 15/215,057

(22) Filed: Jul. 20, 2016

(30) Foreign Application Priority Data
Jul. 22, 2015 (JP) 2015-145354

(51) Int. Cl. B60W 20/13; B60W 50/14; B60W 30/18; B60W 10/06; B60W 10/08

(52) U.S. Cl. CPC B60W 20/13; B60W 10/06; B60W 10/08; B60W 30/18009; B60W 50/14; B60W 2550/142; B60W 2550/402; B60W 2050/146; B60W 2710/0666; B60W 2710/083; Y10S 903/93

(57) ABSTRACT

A control apparatus for a hybrid vehicle including an internal combustion engine, a motor, and a storage battery and configured to charge the storage battery with electric power generated as a result of regenerative braking and electric power generated by using output of the engine. The control apparatus extracts a downhill section contained in a planned travel route of the vehicle and executes downhill control which decreases the remaining capacity of the storage battery before the vehicle enters the downhill section. When the control apparatus extracts the downhill section as a target of the downhill control, if the downhill section contains a flat section whose distance is greater than a predetermined threshold, the control apparatus determines the downhill section is not a target of the downhill control.

### BACKGROUND OF THE INVENTION

Field of the Invention

The present invention relates to a hybrid vehicle control apparatus which includes both an internal combustion engine and a motor as drive sources of the vehicle.

Description of the Related Art

There has been known a hybrid vehicle (hereinafter also referred to as the “vehicle” for simplicity) which includes both an internal combustion engine (hereinafter also referred to as the “engine” for simplicity) and a motor as drive sources of the vehicle. Such a vehicle includes a storage battery which supplies electric power to the motor and which is charged by output of the engine.

In addition, when rotation of a wheel axle is transmitted to the motor, the motor generates electric power (i.e., an electric generator generates electric power), and the storage battery is charged by the electric power as well. Namely, the kinetic energy of the vehicle is converted to electrical energy, and the electrical energy is collected by the storage battery. This energy conversion is also called “regeneration.” When regeneration is performed, the motor generates a force for breaking the vehicle (torque for decreasing the speed of the vehicle). The braking force is also called “regenerative braking force.”

The fuel efficiency (fuel consumption rate) of the vehicle can be improved by collecting, by means of regeneration during deceleration, a portion of energy consumed by the engine or the motor during acceleration or constant-speed travel of the vehicle, and storing the collected energy in the storage battery. During travel of the vehicle, the remaining capacity SOC (State of Charge) of the storage battery fluctuates.

Deterioration of the storage battery accelerates as a result of an increase in the remaining capacity SOC when the remaining capacity SOC is high and as a result of a decrease in the remaining capacity SOC when the remaining capacity SOC is low. Therefore, during travel of the vehicle, the control apparatus of the vehicle maintains the remaining capacity SOC at a level between a predetermined remaining capacity upper limit and a predetermined remaining capacity lower limit.

Incidentally, in the case where the vehicle travels in a downhill section, the vehicle continuously accelerates even when neither the engine nor the motor generates torque. Therefore, a driver of the vehicle removes his/her foot from the accelerator pedal and may press down on the brake pedal so as to request the vehicle to produce braking force. At that time, the vehicle restrains an increase in the vehicle speed by means of regenerative braking force and increases the remaining capacity SOC.

When the remaining capacity SOC increases; i.e., when the amount of electric power stored in the storage battery increases, the vehicle can travel over a longer distance by using the output of the motor only without operating the engine. Accordingly, if the remaining capacity SOC can be increased as much as possible within a range below the remaining capacity upper limit when the vehicle travels in a downhill section, the fuel efficiency of the vehicle can be improved further.

However, when the downhill section is long, the remaining capacity SOC reaches the remaining capacity upper limit, which makes it impossible to increase the remaining capacity SOC further. Accordingly, the greater the difference between the remaining capacity upper limit and the remaining capacity SOC at the start point of the downhill section, the greater the effect in improving fuel efficiency attained as a result of the travel in the downhill section.

In view of the foregoing, one conventional drive control apparatus (hereinafter also referred to as the “conventional apparatus”) raises the remaining capacity upper limit and lowers the remaining capacity lower limit when a travel route contains a downhill section having a predetermined height difference. In addition, the conventional apparatus puts higher priority to travel by means of the motor than to travel by means of the engine such that the remaining capacity SOC approaches the “lowered remaining capacity lower limit” to the greatest extent possible before the vehicle enters the downhill section (see, for example, Japanese Patent Application Laid-Open (kokai) 2005-160269).

Incidentally, in order to execute a control (downhill control) for increasing the remaining capacity SOC, while the vehicle is travelling in a downhill section, to thereby improve the fuel efficiency of the vehicle without fail, it is necessary to properly extract a downhill section (target downhill section) which is contained in a planned travel route and which is subjected to the downhill control. The conventional apparatus has extracted such a target downhill section by paying attention only to the above-mentioned predetermined height difference. In other words, for extraction of such a target downhill section, the conventional apparatus did not take into consideration a length of the downhill section (distance from the start point to the end point of the downhill) and whether or not flat roads are contained in the downhill section partly.

Therefore, the conventional apparatus may not extract a downhill section as the target-downhill section in which the remaining capacity SOC increases by a predetermined amount by executing the downhill control during the vehicle travels. Meanwhile, the conventional apparatus may execute the downhill control although the remaining capacity SOC does not increase by the predetermined amount during travel in the downhill section.

### SUMMARY OF THE INVENTION

One object of the present invention is to provide a hybrid vehicle control apparatus which can properly extract a target downhill section contained in a planned travel route of a vehicle.

A hybrid vehicle control apparatus according to the present invention for achieving the above-described object (hereinafter also referred to as the “present invention apparatus”) is applied to a hybrid vehicle which includes an internal combustion engine and a motor as drive sources of the vehicle, includes a storage battery for supplying electric power to the motor, and is configured to perform regenerative braking by using the motor, and charge the storage battery with electric power generated as a result of the regenerative braking and electric power generated by using output of the internal combustion engine.

The present invention apparatus comprises a controller which controls the internal combustion engine and the motor in such a manner that a demanded drive force for the vehicle is satisfied and the remaining capacity of the storage battery approaches a predetermined target remaining capacity. The controller comprises a downhill determination portion and a downhill control portion.

The downhill determination portion obtains information concerning a plurality of links representing a planned travel route of the vehicle and determines whether or not a target downhill section which satisfies a predetermined condition is contained in the planned travel route on the basis of the obtained information.

In the case where the downhill determination portion determines the target downhill section is contained, the downhill control portion executes downhill control when the vehicle travels in a particular section of a section which extends to “the end point of the target downhill section” from “a downhill control start point which is shifted back from the start point of the target downhill section by a predetermined first distance.” The particular section contains at least a section extending from the downhill control start point to the start point of the target downhill section. The downhill control changes the target remaining capacity to a remaining capacity smaller as compared with the case where the vehicle travels in sections other than the particular section.

Further, the downhill determination portion determines a section represented by a set of links which are continuous links and contained in the obtained plurality of links is a target downhill section, when the set of links satisfies all of the following conditions.

(a) A section corresponding to a start link which is the closest to the vehicle among the set of links is a downhill in which the gradient is greater than a gradient represented by a predetermined gradient threshold.
(b) The height of the end point is lower than the height of the start point.
(c) The height difference between the start point and the end point is greater than a predetermined height difference threshold.
(d) A section which corresponds to a link or continuous links, in which the gradient isn't greater than a gradient represented by the gradient threshold and whose distance is greater than a predetermined second distance isn't contained between the start point and the end point.

Although the height difference between the start point and the end point is large, when a long flat section is contained midway, because an acceleration generated by the gravity is small while the vehicle is travelling in the flat section, the remaining capacity cannot be increased by the regenerative braking. In addition, because of necessity to drive the motor, the remaining capacity doesn't increase. Therefore, the present invention apparatus takes into account the above-described condition (d). So when a flat section which is greater than the second distance, the present invention apparatus doesn't determine the downhill section is the target downhill section.

Accordingly, the present invention apparatus can extract the target downhill section properly to thereby increase the remaining capacity by the downhill control and improve the fuel efficiency of the vehicle.

### BRIEF DESCRIPTION OF THE DRAWINGS

FIG. 1 is a schematic illustration of a vehicle (present vehicle) to which a hybrid vehicle control apparatus (present control apparatus) according to an of the present invention is applied;

FIG. 2 is an alignment chart which represents the relation among rotational speeds of a first motor, a second motor, an engine, and a ring gear;

FIG. 3 is a graph which shows a change in remaining capacity when the present vehicle travels through a target downhill section;

FIG. 4 is an illustration which shows examples of a downhill section which satisfies the conditions for target downhill sections and an example of a downhill section which does not satisfy the conditions for target downhill sections;

FIG. 5 is a flowchart showing drive force control processing executed by the present control apparatus;

FIG. 6 is a graph showing the relation between vehicle speed and accelerator operation amount, and demanded ring gear torque;

FIG. 7 is a graph showing the relation between remaining capacity difference and demanded charge output;

FIG. 8 is a flowchart showing control section setting processing executed by the present control apparatus;

FIG. 9 is a flowchart showing target downhill search processing executed by the present control apparatus; and

FIG. 10 is a flowchart showing downhill control execution processing executed by the present control apparatus.

### DESCRIPTION OF THE PREFERRED EMBODIMENTS

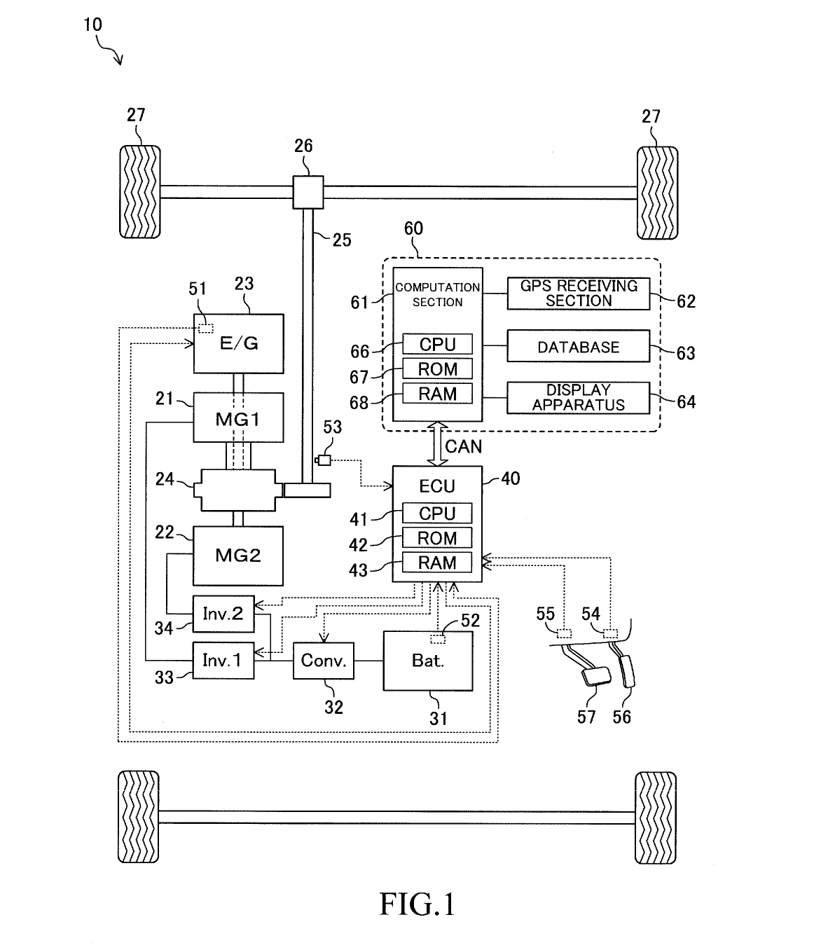

Hybrid vehicle control apparatuses according to embodiments of the present invention (hereinafter also referred to as the “present control apparatus”) will now be described with reference to the drawings. FIG. 1 is a schematic illustration of a vehicle 10 to which the present control apparatus is applied. The vehicle 10 includes a first motor 21, a second motor 22, and an engine 23. Namely, the vehicle 10 is a hybrid vehicle.

The vehicle 10 further includes a power split mechanism 24, a storage battery 31, a step-up converter 32, a first inverter 33, a second inverter 34, an ECU (Electric Control Unit) 40, and a travel assisting apparatus 60. The ECU 40 and the travel assisting apparatus 60 constitute the present control apparatus.

Each of the first motor 21 and the second motor 22 includes a stator having three-phase windings (coils) which generate rotating magnetic fields and a rotor having permanent magnets which generate torque by magnetic force between the rotating magnetic fields and the permanent magnets. Each of the first motor 21 and the second motor 22 functions as a generator and a motor.

The first motor 21 is mainly used as a generator. The first motor 21 also cranks the engine 23 when the engine 23 is to be started. The second motor 22 is mainly used as a motor and can generate vehicle drive force (torque for causing the vehicle to travel) for the vehicle 10. The engine 23 can also generate vehicle drive force for the vehicle 10. The engine 23 is a four-cylinder, four-cycle gasoline engine.

The power split mechanism 24 is a planetary gear mechanism. The power split mechanism 24 includes a ring gear, a plurality of power split planetary gears, a plurality of reduction planetary gears, a first sun gear, a second sun gear, a first planetary carrier, and a second planetary carrier (all the components are not shown).

Each of the power split planetary gears and the reduction planetary gears is in meshing engagement with the ring gear. The first sun gear is in meshing engagement with the power split planetary gears. The second sun gear is in meshing engagement with the reduction planetary gears. The first planetary carrier holds the plurality of power split planetary gears in such a manner that the power split planetary gears can rotate about their axes, respectively, and the power split planetary gears can revolve around the first sun gear. The second planetary carrier holds the plurality of reduction planetary gears in such a manner that the reduction planetary gears can rotate about their axes, respectively.

The ring gear is connected to an axle 25 through a counter gear disposed on the outer periphery of the ring gear in such a manner that torque can be transmitted from the ring gear to the axle 25. The output shaft of the engine 23 is coupled to the first planetary carrier in such a manner that torque can be transmitted from the output shaft of the engine 23 to the first planetary carrier. The output shaft of the first motor 21 is coupled to the first sun gear in such a manner that torque can be transmitted from the output shaft of the first motor 21 to the first sun gear. The output shaft of the second motor 22 is coupled to the second sun gear in such a manner that torque can be transmitted from the output shaft of the second motor 22 to the second sun gear.

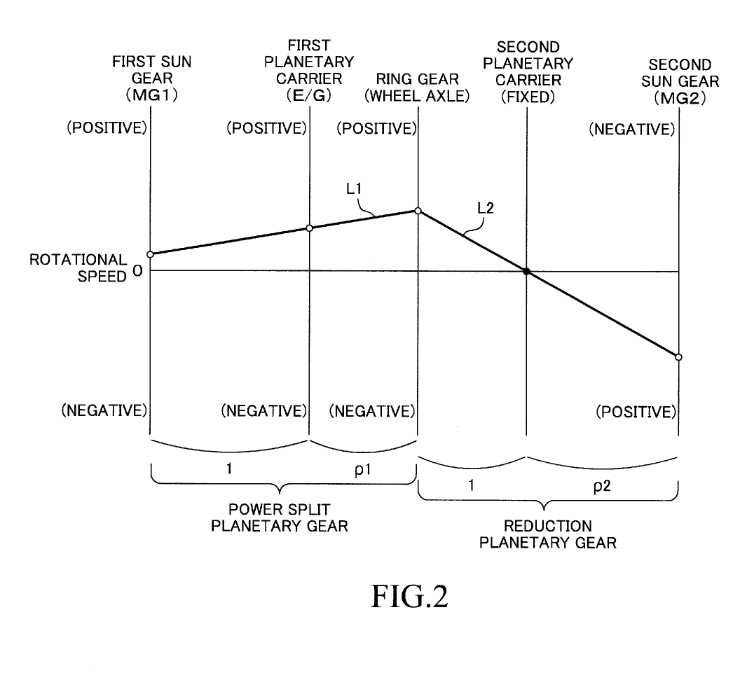

The relation among the rotational speed (MG1 rotational speed) Nm1 of the first motor 21, the engine rotational speed NE of the engine 23, and the ring gear rotational speed Nr of the power split mechanism 24, and the relation between the rotational speed (MG2 rotational speed) Nm2 of the second motor 22 and the ring gear rotational speed Nr are represented by a well-known alignment chart shown in FIG. 2. The two straight lines shown in the alignment chart will be also referred to as an operation collinear line L1 and an operation collinear line L2.

According to the operation collinear line L1, the relation between the MG1 rotational speed Nm1, and the engine rotational speed NE and the ring gear rotational speed Nr can be represented by the following expression (1). The gear ratio ρ1 in the expression (1) is the ratio of the number of the teeth of the first sun gear to the number of the teeth of the ring gear (namely, ρ1=the number of the teeth of the first sun gear/the number of the teeth of the ring gear).

Nm1=Nr−(Nr−NE)×(1+ρ1)/ρ1 (1)

Meanwhile, according to the operation collinear line L2, the relation between the MG2 rotational speed Nm2 and the ring gear rotational speed Nr can be represented by the following expression (2). The gear ratio ρ2 in the expression (2) is the ratio of the number of the teeth of the second sun gear to the number of the teeth of the ring gear (namely, ρ2=the number of the teeth of the second sun gear/the number of the teeth of the ring gear).

Nm2=Nr×(1+ρ2)/ρ2−Nr (2)

Referring back to FIG. 1, the axle 25 is coupled to drive wheels 27 through a differential gear 26 in such a manner that torque can be transmitted from the axle 25 to the drive wheels 27.

The storage battery 31 is a secondary battery (lithium ion battery in the present embodiment) which can be charged and discharged. DC electric power output from the storage battery 31 undergoes voltage conversion (step-up) performed by the step-up converter 32 and becomes high-voltage electric power. The first inverter 33 converts the high-voltage electric power to AC electric power and supplies the AC electric power to the first motor 21. Similarly, the second inverter 34 converts the high-voltage electric power to AC electric power and supplies the AC electric power to the second motor 22.

Meanwhile, when the first motor 21 operates as a generator, the first inverter 33 converts the generated AC electric power to DC electric power and supplies the DC electric power to the step-up converter 32 and/or the second inverter 34. Similarly, when the second motor 22 operates as a generator, the second inverter 34 converts the generated AC electric power to DC electric power and supplies the DC electric power to the step-up converter 32 and/or the first inverter 33. The step-up converter 32 steps down the DC electric power supplied from the first inverter 33 and/or the second inverter 34 and supplies the stepped down DC electric power to the storage battery 31. As a result, the storage battery 31 is charged.

The ECU 40 is a microcomputer which includes a CPU 41, a ROM 42 for storing programs to be executed by the CPU 41, lookup tables (maps), etc., a RAM 43 for temporarily storing data, and other necessary components. The ECU 40 controls the engine 23, the step-up converter 32, the first inverter 33, and the second inverter 34.

The ECU 40 is connected to a crank angle sensor 51, an ammeter 52, a vehicle speed sensor 53, an accelerator operation amount sensor 54, and a brake operation amount sensor 55.

The crank angle sensor 51 measures the rotational position of the crankshaft of the engine 23 and outputs a signal which represents its crank angle CA. The ECU 40 calculates the engine rotational speed NE of the engine 23 on the basis of the crank angle CA. The ammeter 52 outputs a signal which represents current IB flowing through the storage battery 31. The ECU 40 calculates a remaining capacity SOC, which is the amount of electric power charged in the storage battery 31, on the basis of the current IB.

The vehicle speed sensor 53 detects the rotational speed of the axle 25 and outputs a signal which represents the travel speed (vehicle speed) Vs of the vehicle 10. The accelerator operation amount sensor 54 outputs a signal which represents the operation amount (accelerator operation amount) Ap of an accelerator pedal 56. The brake operation amount sensor 55 outputs a signal which represents the operation amount (brake operation amount) Bp of a brake pedal 57.

The travel assisting apparatus 60 includes a computation section 61, a GPS receiving section 62, a database 63, and a display apparatus 64.

The GPS receiving section 62 obtains the present position Pn of the vehicle 10 on the basis of signals (radio waves) from GPS (Global Positioning System) satellites and outputs a signal representing the present position Pn to the computation section 61.

The database 63 is formed by a hard disk drive (HDD) and stores a map database. The map database includes information (map information) regarding “nodes” such as intersections, dead ends, etc., “links” which connect the nodes, and “facilities” such as buildings, parking lots, etc. located along the links. Further, the map database includes pieces of information provided for each link; i.e., the distance of a section (road), the positions of nodes specifying one end (start position) and the other end (end position) of each link, and the average gradient of each link (the ratio of the height difference between the opposite ends of the link to the distance between the opposite ends of the link).

The display apparatus 64 is disposed on a center console (not shown) provided within the compartment of the vehicle 10. The display apparatus 64 has a display and can display the map information stored in the map database, together with the present position Pn, in response to an operation by a driver of the vehicle 10.

The display of the display apparatus 64 also operates as a touch panel. Accordingly, the driver can operate the travel assisting apparatus 60 by touching the display of the display apparatus 64. Further, the display apparatus 64 includes a sound generation unit (not shown). The display apparatus 64 can perform reproduction of a warning beep and announce a message, etc., in accordance with instructions from the computation section 61.

The computation section 61 is a microcomputer which includes a CPU 66, a ROM 67 for storing programs to be executed by the CPU 66, lookup tables (maps), etc., a RAM 68 for temporarily storing data, and other necessary components. The computation section 61 can exchange information with the ECU 40 through a CAN (Controller Area Network). The computation section 61 will be also referred to as the “travel assisting ECU,” and the ECU 40 will be also referred to as the “vehicle control ECU.”

When the driver of the vehicle 10 enters a destination by using the display apparatus 64, the computation section 61 searches a route (planned travel route) from the present position Pn to the destination on the basis of the map database. The planned travel route is defined by a group of links. The computation section 61 provides a route guidance by using displays on the display apparatus 64 and sounds generated from the sound generation unit such that the driver can pass through the planned travel route.

(Control of Generated Torque by ECU)

Next, operation of the ECU 40 will be described.

When the driver demands the vehicle 10 to generate a drive force (torque), the driver performs an operation for increasing the accelerator operation amount Ap. The ECU 40 determines a demanded ring gear torque Tr*, which is a target value of the torque (ring gear generation torque) Tr acting on the ring gear, on the basis of the accelerator operation amount Ap and the vehicle speed Vs. Since the ring gear generation torque Tr is in proportion to the torque acting on the drive wheels 27, the torque acting on the drive wheels 27 increases as the ring gear generation torque Tr increases.

The ECU 40 controls the engine 23, the step-up converter 32, the first inverter 33, and the second inverter 34 such that the ring gear generation torque Tr becomes equal to the demanded ring gear torque Tr* and the remaining capacity SOC coincides with (approaches) a target remaining capacity SOC*.

For example, in the case where the remaining capacity SOC approximately coincides with the target remaining capacity SOC*, in an operation region within which the operation efficiency of the engine 23 is high, the ECU 40 causes both the engine 23 and the second motor 22 to generate outputs, and causes the first motor 21 to generate electric power by using a portion of the engine output Pe (the output of the engine 23). In this case, the electric power generated by the first motor 21 is supplied to the second motor 22. Accordingly, the remaining capacity SOC is maintained at the target remaining capacity SOC*.

In the case where the remaining capacity SOC is lower than the target remaining capacity SOC*, the ECU 40 increases the engine output Pe to thereby increase the amount of electric power generated by the first motor 21. As a result, the remaining capacity SOC increases.

Meanwhile, when the engine 23 is in an operation region within which the operation efficiency of the engine 23 is low (for example, at the time of start of the vehicle 10 and at the time of low-load travel), the ECU 40 stops the operation of the engine 23 and causes the second motor 22 only to generate an output. In this case, the remaining capacity SOC decreases. However, when the remaining capacity SOC is less than a remaining capacity lower limit Smin, the ECU 40 executes “forced charging” by operating the engine 23 and causing the first motor 21 to generate electric power. As a result, the remaining capacity SOC becomes greater than the remaining capacity lower limit Smin.

In the case where the remaining capacity SOC is greater than a remaining capacity upper limit Smax, even when the engine 23 is in the operation region within which the operation efficiency of the engine 23 is high, the ECU 40 stops the operation of the engine 23 except the case where a large output and a large torque are demanded, and causes the second motor 22 only to generate an output. As a result, the remaining capacity SOC becomes less than the remaining capacity upper limit Smax.

(Control of Braking Force by ECU)

When the driver demands the vehicle 10 to generate a braking force, the driver performs an operation for setting both the accelerator operation amount Ap and the brake operation amount Bp to “0” or an operation for increasing the brake operation amount Bp after setting the accelerator operation amount Ap to “0.” When the generation of a braking force is demanded, the ECU 40 generates a regenerative braking force and a frictional braking force. At that time, the regenerative braking force is supplemented by the frictional braking force to generate the demanded braking force.

When the regenerative braking force is to be generated, the ECU 40 causes the first motor 21 and/or the second motor 22 to generate electric power. In other words, the ECU 40 converts the kinetic energy of the vehicle 10 to electrical energy through use of the first motor 21 and/or the second motor 22. The generated electric power is charged in the storage battery 31, whereby the remaining capacity SOC increases.

When the frictional braking force is to be generated, the ECU 40 requests a brake apparatus (not shown) to apply frictional forces to brake discs provided on the wheels of the vehicle 10, including the drive wheels 27. In other words, the ECU 40 converts the kinetic energy of the vehicle 10 to thermal energy through use of the brake apparatus.

The ECU 40 controls the first motor 21, the second motor 22, and the brake apparatus such that the total braking force, which is the sum of the regenerative braking force and the frictional braking force, becomes equal to the braking force demanded by the driver.

(Downhill Control)

In the case where the vehicle 10 travels in a downhill section, if the vehicle 10 generates no braking force, the vehicle speed Vs increases even when no torque is transmitted to the drive wheels 27. When the vehicle speed Vs becomes higher than a speed which the driver expects, the driver demands a braking force. The entirety or a portion of the demanded braking force is provided by the regenerative braking force. Therefore, during the travel in the downhill section, the frequency at which the first motor 21 and/or the second motor 22 generates electric power increases, whereby the remaining capacity SOC increases. In other words, the ECU 40 converts the potential energy of the vehicle 10 to kinetic energy and then to electrical energy.

When the remaining capacity SOC increases, the frequency at which the engine 23 is operated to charge the storage battery 31 decreases, and a portion of the output of the engine 23, which portion is used for charging the storage battery 31, decreases. Therefore, the fuel efficiency of the vehicle 10 improves. However, when the remaining capacity SOC reaches the remaining capacity upper limit Smax in the middle of the downhill section, it becomes impossible to increase the remaining capacity SOC more and improve the fuel efficiency more.

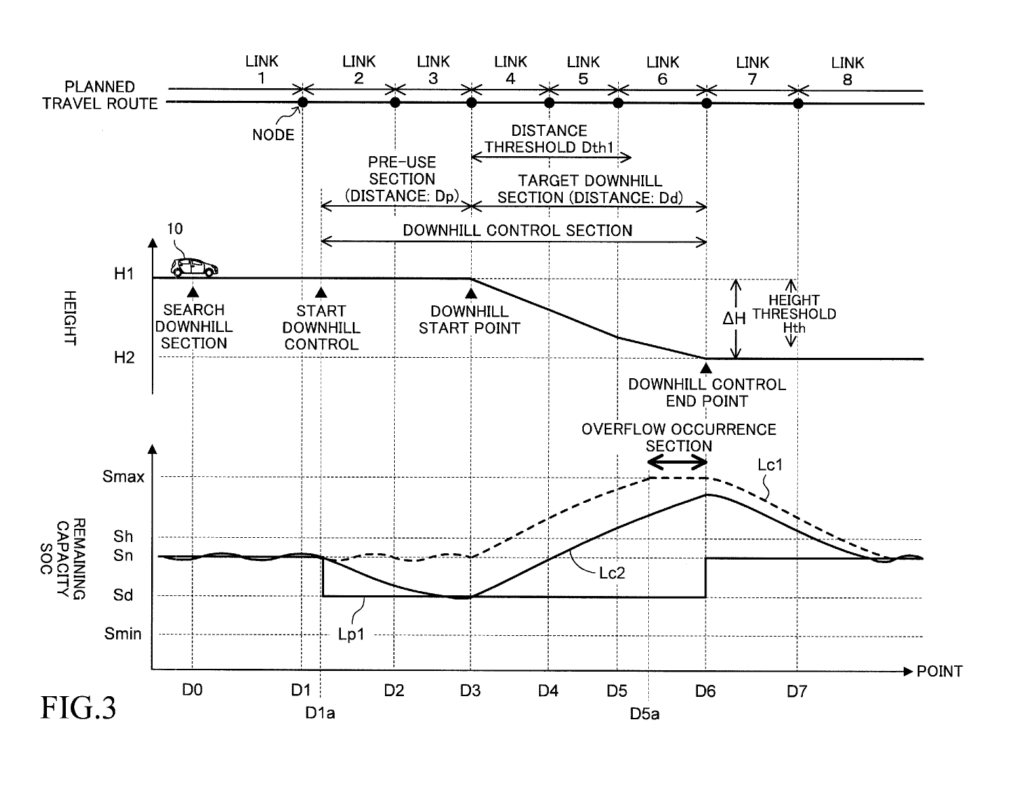

A change in the remaining capacity SOC at the time when the vehicle 10 travels through a downhill section will be described with reference to FIG. 3. In FIG. 3, the links defining or constituting a planned travel route of the vehicle 10 are denoted as link 1 to link 8 for convenience' sake. The present position Pn is located on link 1. Link 4 to link 6 correspond to a target downhill section which will be described later. Meanwhile, link 1 to link 3, link 7, and link 8 correspond to flat roads. When the downhill control to be described later is not executed, the target remaining capacity SOC* is set to a standard remaining capacity Sn.

A curved line Lc1 (broken line) shows a change in the remaining capacity SOC at the time when the vehicle 10 travels from link 1 to link 8 without executing the downhill control. When the vehicle 10 travels through link 1 to link 3, the operations of the engine 23, the first motor 21, and the second motor 22 are controlled such that the remaining capacity SOC approaches the standard remaining capacity Sn which is the target remaining capacity SOC*. Therefore, the remaining capacity SOC fluctuates near the standard remaining capacity Sn. When the vehicle 10 enters a section corresponding to link 4, the remaining capacity SOC starts to increase due to regenerative braking, and when the vehicle 10 reaches a point D5a which is located midway of link 6, the remaining capacity SOC reaches the remaining capacity upper limit Smax.

Therefore, when the vehicle 10 travels between point D5a and point D6, despite the fact that the vehicle 10 travels in a downhill section, the vehicle 10 cannot perform regenerative braking. Therefore, the remaining capacity SOC cannot be increased (namely, overflow occurs), and the fuel efficiency improving effect is not attained sufficiently. In addition, if the time over which the remaining capacity SOC is maintained at a level near the remaining capacity upper limit Smax becomes long, deterioration of the storage battery 31 is accelerated.

In view of this, before the downhill section, the ECU 40 of the vehicle 10 executes “downhill control” of decreasing the target remaining capacity SOC* by a predetermined amount (electric power amount S10). When the downhill control is executed, the target remaining capacity SOC* is set to a remaining capacity (low-side remaining capacity) Sd. In the present embodiment, the magnitude of the difference between the standard remaining capacity Sn and the low-side remaining capacity Sd is equal to the electric power amount S10 which corresponds to 10% the maximum charge amount of the storage battery 31 (namely, the amount of stored electric power at the time when the remaining capacity SOC is 100%) (namely, Sd=Sn−S10).

The downhill control is started when the vehicle 10 reaches a point D1a which is shifted back (toward the start point of the planed travel route) from the start point D3 of the downhill section by a predetermined pre-use distance Dp. Meanwhile, the downhill control is ended when the vehicle 10 reaches the end point D6 of the downhill section, and the target remaining capacity SOC* is changed from the low-side remaining capacity Sd to the standard remaining capacity Sn. A change in the target remaining capacity SOC* in the case where the downhill control is executed is shown by a polygonal line Lp1.

A section composed of the downhill section and the “pre-use section” (between the point shifted back from the start point D3 of the downhill section by the predetermined pre-use distance Dp and the start point of the downhill section) will be also referred to as the “downhill control section.” The pre-use distance Dp is a distance set in advance and is sufficiently large so that when the vehicle 10 travels over that distance, the remaining capacity SOC is gradually decreased by the electric power amount S10.

A change in the remaining capacity SOC in the case where the downhill control is executed is shown by a curved line Lc2 (continuous line). As can be understood from the curved line Lc2, when the target remaining capacity SOC* is set to the low-side remaining capacity Sd at point D1a, the remaining capacity SOC decreases and reaches a level near the low-side remaining capacity Sd. When the vehicle 10 travels through the downhill section after that, the remaining capacity SOC increases. However, the vehicle 10 ends the travel through the downhill section before the remaining capacity SOC reaches the remaining capacity upper limit Smax. Namely, as a result of the downhill control, occurrence of the above-described overflow can be avoided.

When the vehicle 10 reaches the start point of the downhill control section (point D1a), the ECU 40 receives a notice which indicates that the downhill control must be started, from the travel assisting apparatus 60 (specifically, the computation section 61). The processing which the computation section 61 executes will be described later. Similarly, the vehicle 10 reaches the end point of the downhill control section (point D6), ECU 40 receives a notice which indicates that the downhill control must be stopped, from the computation section 61. The ECU 40 starts the downhill control, and then stops the downhill control, according to the notices receiving from the computation section 61.

The downhill section which is the target of the downhill control (target downhill section) is a downhill section in which an increase in the remaining capacity SOC due to the above-described conversion of potential energy to electrical energy is expected to become greater than an “electric power amount S20 corresponding to 20% the maximum charge amount of the storage battery 31.” In the present embodiment, target downhill section is a downhill section where a distance between the start (point D3) point and the end point (point D6) is greater than a distance threshold Dth1, and where the height of the end point is lower than the height of the start point and the height difference is greater than the height difference threshold Hth.

In the example of FIG. 3, the distance of a downhill section constituted by link 4 to link 6 (namely, a section from point D3 to point D6) is Dd and the distance Dd is greater than the distance threshold Dth1 (namely, Dd=Dth1). In addition, the height of the start point of the downhill section (namely, the start point D3 of link 4) is H1, the height of the end point (namely, the end point D6 of link 6) is H2 and the height deference ΔH between H1 and H2 is greater than the height threshold Hth (namely, ΔH=H1−H2>Hth). Accordingly, the downhill section constituted by link 4 to link 6 is therefore a target downhill section.

Notably, as described above, the length and gradient of each link are stored in the map database. Therefore, the computation section 61 obtains the height difference between one end and the other end of each link by calculating the product of the length and gradient of the link. Further, the computation section 61 obtains the height difference between one end and the other end of a certain section by calculating the sum of the height differences of a plurality of links which constitute the certain section. Notably, in the case where the map database contains the heights of opposite ends of each link, the height difference of each link is obtained by subtracting the height of the start point of the link from the height of the end point of the link.

(Extraction Processing of Target Downhill Section)

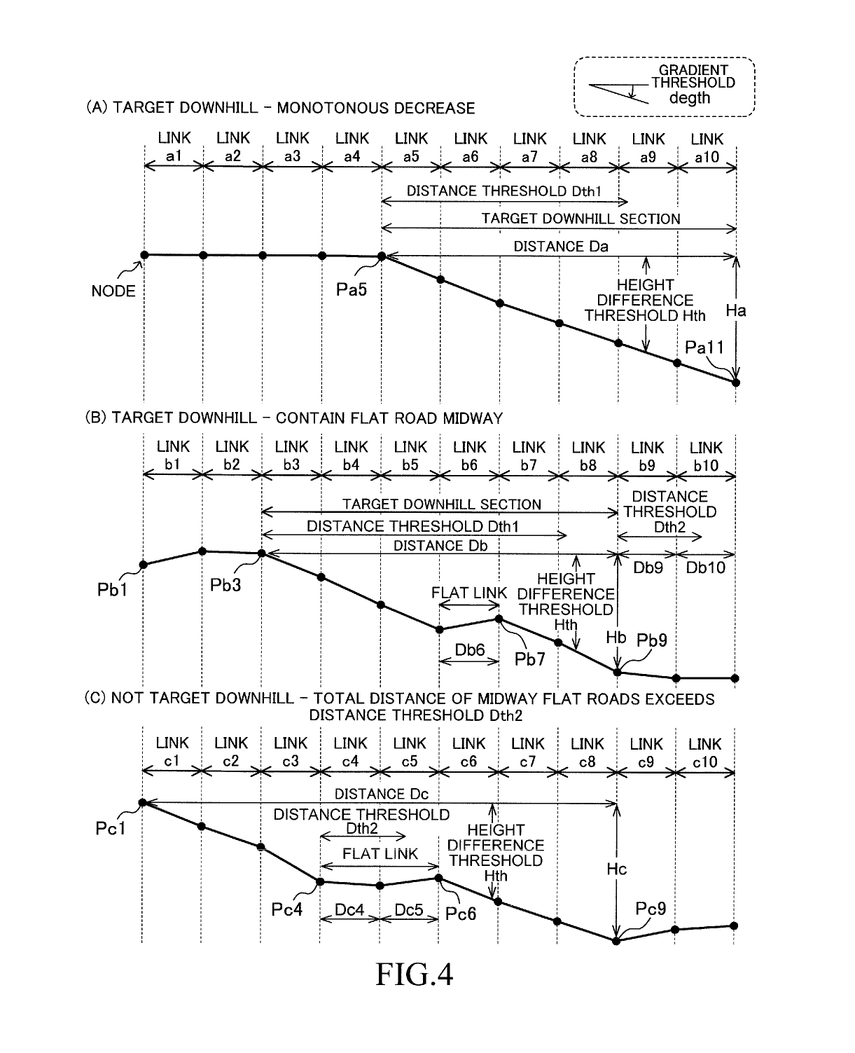

The extraction method of target downhill section will be described with reference to an example shown in FIG. 4. Each of (A) to (C) of FIG. 4 shows a planned travel route of the vehicle 10 which is constituted by 10 links (link a1 to link a10, link b1 to link b10, and link c1 to link c10).

Links constitute the planned travel route are a set of “downward gradient links” and “flat links.” A downward gradient link is a downhill section in which the average gradient of the link is greater than a gradient represented by a gradient threshold degth (degth<0) (namely, a downhill section whose gradient is greater than the gradient threshold degth). A flat link is a section in which the average gradient of the link is less than the gradient represented by the gradient threshold degth, a flat section, or an uphill section (namely, a downhill section whose gradient isn't greater than the gradient threshold degth).

The gradient threshold degth is a predetermined value. The gradient threshold degth is set such that when the travel route of the vehicle 10 is a downhill section whose gradient is greater than the gradient threshold degth, the amount of energy converted from the above-described potential energy to electrical energy increases to some extent.

The necessary conditions for extraction the entirety or a portion of a set of links constituting the planned travel route as a target downhill section (target downhill section conditions) are as follows.

(a) A section represented by the “start link” which is a link closest to the vehicle 10 among the set of links is a downward gradient link.
(b) The distance between the “start point” of the section corresponding to the start link and the “end point” of the section corresponding to the “end link” which is a link farthest to the vehicle 10 is greater than the distance threshold Dth1.
(c) The height of the end point is lower than the height of the start point.
(d) The height difference is greater than a height difference threshold Hth.
(e) A section corresponding to one link or a plurality of continuous links between the start point and the end point is not a section which is constituted by flat links and is greater than a distance threshold Dth2 which is less than the distance threshold Dth1 (namely, Dth2<Dth1).

In the example of (A) of FIG. 4, each of link a1 to link a4 is a flat link. Meanwhile, each of link a5 to link a10 is a downward gradient link. The total distance Da of a section represented by link a5 to link a10 is greater than the distance threshold Dth1. The height difference Ha between the start point Pa5 of link a5 and the end point Pa11 of link a10 is greater than a height difference threshold Hth. The height of the end point Pa11 is lower than the height of the start point Pa5. Accordingly, since the section of link a5 to link a10 satisfies all the above-described conditions (a), (b), (c), (d), and (e). Therefore, the section of link a5 to link a10 constitutes a target downhill section. Namely, the section from the point Pa5 to the point Pa11 is a target downhill section.

For example, when link a4 to link a10 are considered as a downhill section, the section does not satisfy the above-described condition (a) because link a4 is a flat link. Therefore, the section of link a4 to link a10 is not a target downhill section.

In the example of (B) of FIG. 4, link b3 to link b5 and link b7 to link b8 are downward gradient links. Meanwhile, link b1 to link b2, link b6 and link b9 to b10 are flat links. The total distance Db of a section represented by link b3 to link b8 is greater than the distance threshold Dth1. The height difference Hb between the start point Pb3 of link b3 and the end point Pb9 of link b8 is greater than a height difference threshold Hth. The height of the end point Pb9 is lower than the height of the start point Pb3. Accordingly, the above-described conditions (a), (b), (c), and (d) are satisfied.

In addition, although the section of link b3 to link b9 includes flat link b6, since the distance Db6 between the start point and end point of link b6 is less than the distance threshold Dth2, the above-described condition (e) is satisfied. Accordingly, the section of link b3 to link b8 constitutes a target downhill section.

In the example of (C) of FIG. 4, link c1 to link c3 and link c6 to link c8 are downward gradient links. Meanwhile, link c4 to link c5 and link c9 to c10 are flat links. For example, when link c1 to link c8 are considered as a downhill section, the distance Dc of the section constituted by link c1 to link c8 is greater than the distance threshold Dth1. The height difference Hc between the start point Pc1 of link c1 and the end point Pc9 of link c8 is greater than a height difference threshold Hth. The height of the end point Pc9 is lower than the height of the start point Pd. Accordingly, the above-described conditions (a), (b), (c), and (d) are satisfied.

However, the section of link c1 to link c8 includes flat link c4 and flat link c5. Since the distance (distance Dc4+distance Dc5) from the start point Pc4 of link c4 to the end point Pc6 of link c5 is greater than the distance threshold Dth2, the above-described condition (e) is not satisfied. Accordingly, the section of link c1 to link c8 does not constitute a target downhill section.

(Provision of Information from Travel Assisting Apparatus to ECU)

The computation section 61 searches target downhill sections contained in a route from the present position Pn to a destination (namely, a planned travel route) in accordance with the above-described target downhill section conditions. In the case where a target downhill section is found, when the vehicle 10 reaches the start point of the downhill control section (the start point of the pre-use section), the computation section 61 sends to the ECU 40 a notice which indicates that the downhill control must be started. In addition, when the vehicle 10 reaches the end point of the downhill control section (the end point of the target downhill section), the computation section 61 sends to the ECU 40 a notice which indicates that the downhill control must be stopped.

(Specific Operation—Control of Drive Force by ECU)

Next, specific operation of the ECU 40 will be described.

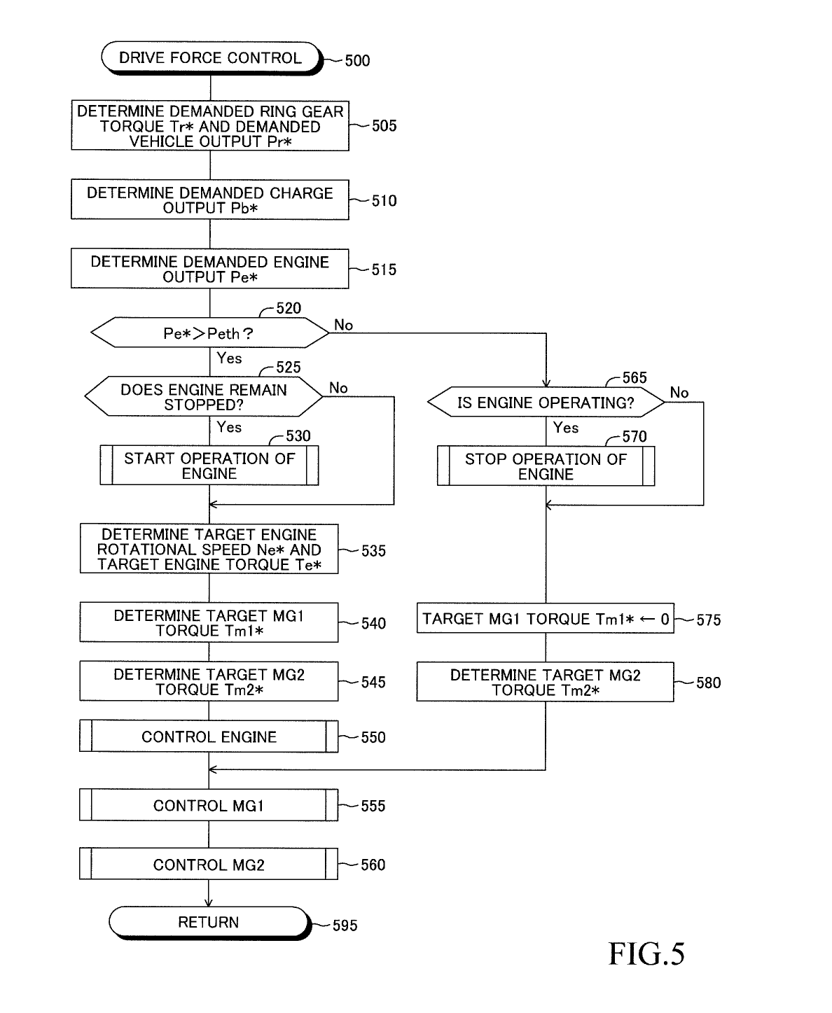

The CPU 41 of the ECU 40 (hereinafter also referred to as the “CPU” for simplicity) executes the “drive force control routine” represented by the flowchart of FIG. 5 every time a predetermined period of time elapses. Accordingly, when a proper timing comes, the CPU starts the processing from step 500 of FIG. 5, successively performs the processings of step 505 to step 515 which will be described later, and proceeds to step 520.

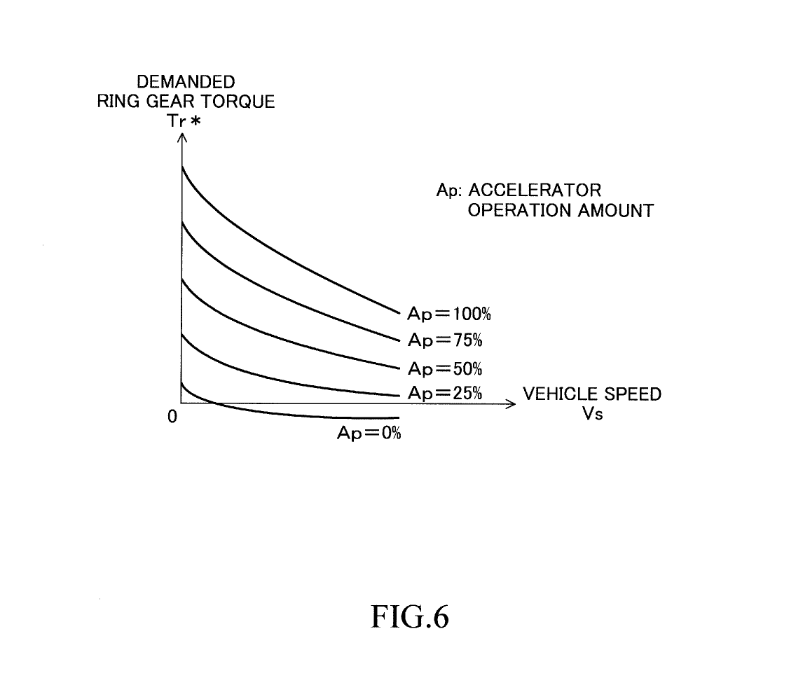

Step 505: The CPU determines a demanded ring gear torque Tr* by applying the accelerator operation amount Ap and the vehicle speed Vs to a “lookup table which defines the relation between the accelerator operation amount Ap and the vehicle speed Vs, and the demanded ring gear torque Tr*” shown in FIG. 6, which is stored in the ROM 42 in a form of a lookup table.

The demanded ring gear torque Tr* is proportional to the torque acting on the drive wheels 27 which the driver requests the vehicle 10 to produce.

Further, the CPU calculates, as a demanded vehicle output Pr*, the product of the demanded ring gear torque Tr* and the ring gear rotational speed Nr (Pr*=Tr*×Nr). The ring gear rotational speed Nr is proportional to the vehicle speed Vs.

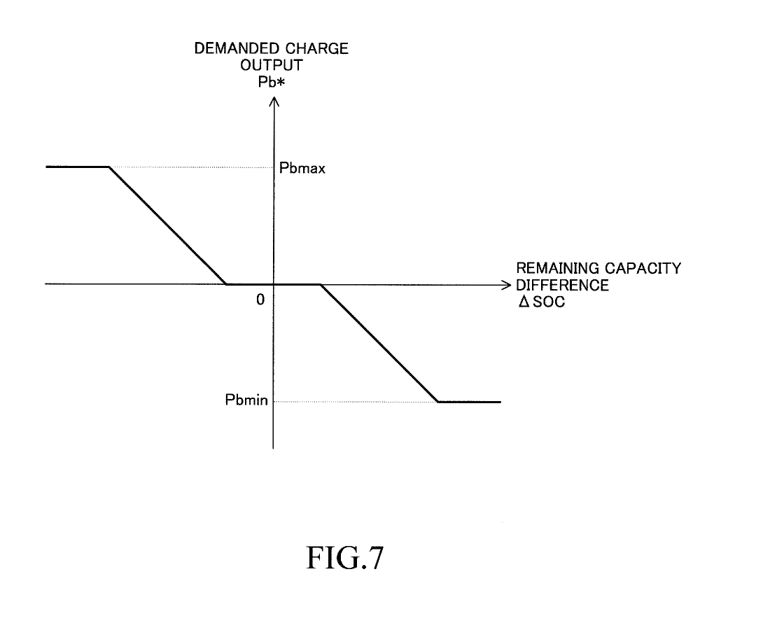

Step 510: The CPU determines a demanded charge output Pb* on the basis of a remaining capacity difference ΔSOC which is the difference between the target remaining capacity SOC* and the actual remaining capacity SOC calculated separately (i.e., ΔSOC=SCO−SOC*). More specifically, the CPU determines the demanded charge output Pb* by applying the remaining capacity difference ΔSOC to a “lookup table which defines the relation between the remaining capacity difference ΔSOC and the demanded charge output Pb*” shown in FIG. 7, which is stored in the ROM 42 in a form of a lookup table.

As can be understood from FIG. 7, the greater the remaining capacity difference ΔSOC, the smaller the value to which the demanded charge output Pb* is set. Accordingly, in the case where the actual remaining capacity SOC is at a certain level, when the target remaining capacity SOC* is decreased, the remaining capacity difference ΔSOC increases, whereby the demanded charge output Pb* decreases. The upper limit of the demanded charge output Pb* is Pbmax (Pbmax>0), and the lower limit of the set demanded charge output Pb* is Pbmin (Pbmin<0). Notably, irrespective of whether or not the downhill control is executed and irrespective of the value of the remaining capacity difference ΔSOC, the demanded charge output Pb* is set to the lower limit Pbmin when the remaining capacity SOC is equal to or greater than the remaining capacity upper limit Smax, and the demanded charge output Pb* is set to the upper limit Pbmax when the remaining capacity SOC is equal to or less than the remaining capacity lower limit Smin.

Step 515: The CPU calculates a demanded engine output Pe* by adding a loss Ploss to the sum of the demanded vehicle output Pr* and the demanded charge output Pb* (i.e., Pe*=Pr*+Pb*+Ploss).

Next, the CPU proceeds to step 520 and judges whether or not the demanded engine output Pe* is greater than an output threshold Peth. The output threshold Peth is set to a value determined such that when the engine 23 is operated to produce an output equal to or less than the output threshold Peth, the operation efficiency of the engine 23 becomes lower than a predetermined efficiency. In addition, the output threshold Peth is set such that when the demanded charge output Pb* is set to the upper limit Pbmax, the demanded engine output Pe* becomes greater than the output threshold Peth.

(Case 1: Pe*>Peth)

In the case where the demanded engine output Pe* is greater than the output threshold Peth, the CPU makes an affirmative judgment (Yes) in step 520 and proceeds to step 525. In step 525, the CPU judges whether or not the engine 23 is in a stopped state at the present. In the case where the engine 23 is in the stopped state, the CPU makes an affirmative judgment (Yes) in step 525 and proceeds to step 530. In step 530, the CPU executes processing of starting the operation of the engine 23. Subsequently, the CPU proceeds to step 535. Meanwhile, in the case where the engine 23 is being operated, the CPU makes a negative judgment (No) in step 525 and proceeds directly to step 535.

The CPU successively performs the processings of step 535 to step 560 which will be described later. After that, the CPU proceeds to step 595 and ends the present routine temporarily.

Step 535: The CPU determines a target engine rotational speed Ne* and a target engine torque Te* such that an output equal to the demanded engine output Pe* is output from the engine 23 and the operation efficiency of the engine 23 becomes the highest. Namely, the CPU determines the target engine rotational speed Ne* and the target engine torque Te* on the basis of the optimum engine operation point corresponding to the demanded engine output Pe*.

Step 540: The CPU calculates a target MG1 rotational speed Nm1* by substituting the ring gear rotational speed Nr and the target engine rotational speed Ne* into the above-described expression (1). Further, the CPU determines a target first motor torque (target MG1 torque) Tm1* which realizes the target MG1 rotational speed Nm1*.

Step 545: The CPU calculates a shortage torque which is the difference between the demanded ring gear torque Tr* and a torque which acts on the ring gear when the engine 23 generates a torque equal to the target engine torque Te*. Further, the CPU calculates a target second motor torque (target MG2 torque) Tm2* which is a torque to be generated by the second motor 22 so as to supplement the shortage torque.

Step 550: The CPU controls the engine 23 in such a manner that the engine torque Te generated by the engine 23 becomes equal to the target engine torque Te* and the engine rotational speed NE becomes equal to the target engine rotational speed Ne*.

Step 555: The CPU controls the first inverter 33 in such a manner that the torque Tm1 generated by the first motor 21 becomes equal to the target MG1 torque Tm1*.

Step 560: The CPU controls the second inverter 34 in such a manner that the torque Tm2 generated by the second motor 22 becomes equal to the target MG2 torque Tm2*.

(Case 2: Pe*≦Peth)

In the case where the demanded engine output Pe* is equal to or less than the output threshold Peth, when the CPU proceeds to step 520, the CPU makes a negative judgment (No) in step 520 and proceeds to step 565 so as to judge whether or not the engine 23 is being operated at the present.

In the case where the engine 23 is being operated, the CPU makes an affirmative judgment (Yes) in step 565 and proceeds to step 570 so as to execute processing of stopping the operation of the engine 23. After that, the CPU proceeds to step 575. Meanwhile, in the case where the engine 23 is in the stopped state, the CPU makes a negative judgment (No) in step 565 and proceeds directly to step 575.

In step 575, the CPU sets the value of the target MG1 torque Tm1* to “0.” Further, the CPU proceeds to step 580 and calculates the target MG2 torque Tm2* which is the torque to be generated by the second motor 22 so as to make the torque acting on the ring gear equal to the demanded ring gear torque Tr*. Subsequently, the CPU proceeds to step 555 to step 560.

(Specific Operation—Search of Target Downhill Section by Travel Assisting Apparatus)

Next, specific operation of the travel assisting apparatus 60 will be described.

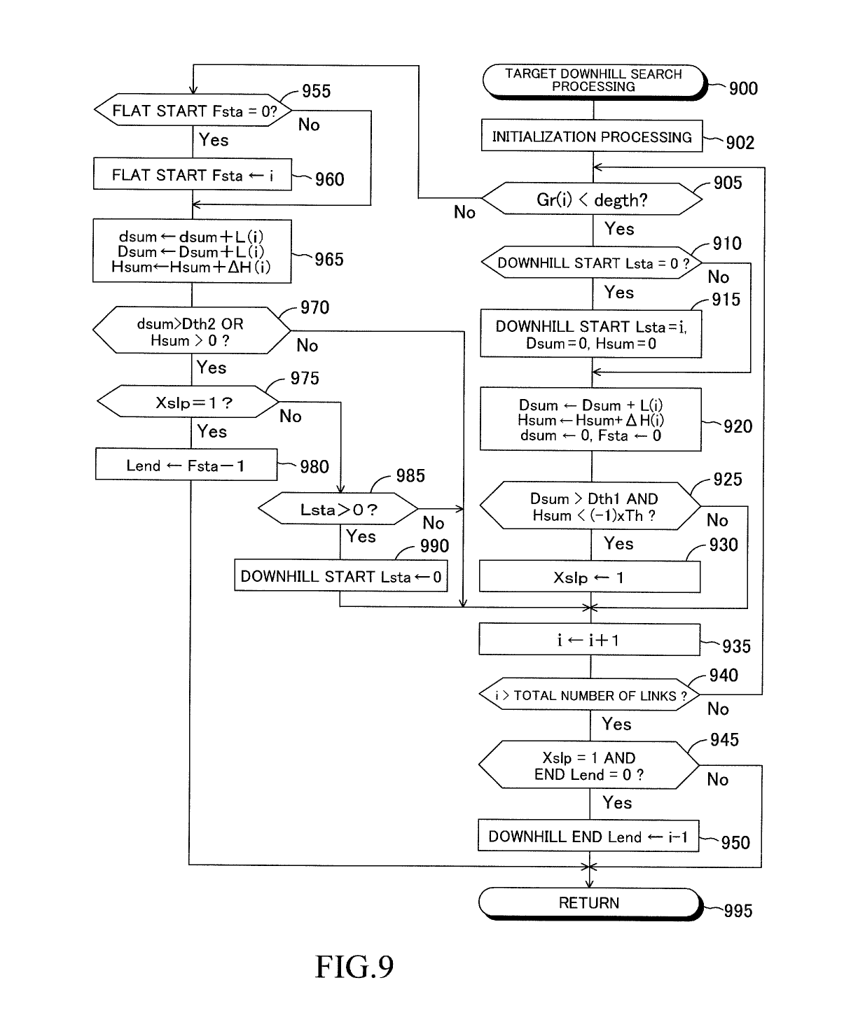

The CPU 66 of the computation section 61 executes a “control section setting processing routine” represented by the flowchart of FIG. 9 when the driver enters a destination and when the vehicle 10 passes through the end point of a target downhill section searched already.

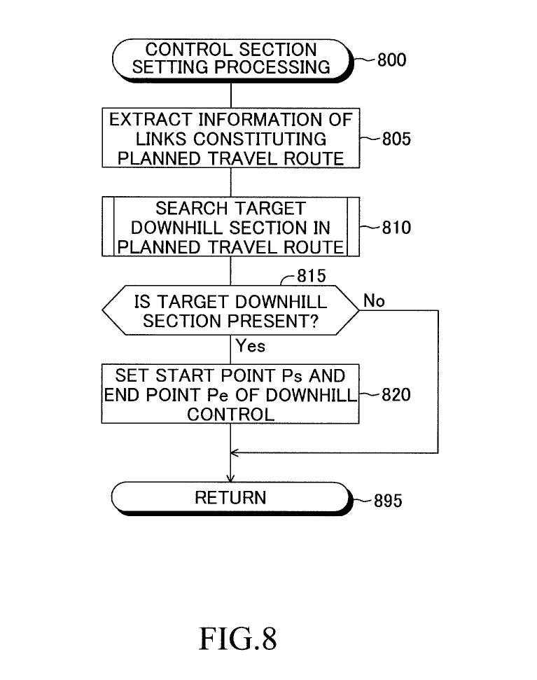

Accordingly, when a proper timing comes, the CPU 66 starts the processing from step 800 of FIG. 8 and proceeds to step 805 so as to extract, from the map database, a planned travel route (a combination of links) extending from the present position Pn to the destination. Notably, in the case where the present routine is executed for the first time after the entry of the destination, the CPU 66 determines a planned travel route on the basis of the present position Pn and the destination and extracts a combination of links of the planned travel route.

Subsequently, the CPU 66 proceeds to step 810 and searches the closest target downhill section located forward of a point on the planned travel route which is separated from the present position Pn by the pre-use distance Dp. The details of target downhill section search processing will be described later. Subsequently, the CPU 66 proceeds to step 815 and determines whether or not the result of the search in step 810 shows that a target downhill section is present.

In the case where a target downhill section is present, the CPU 66 makes an affirmative judgment (Yes) in step 815 and proceeds to step 820. In step 820, the CPU 66 sets, as the start point Ps of the downhill control, a point on the planned travel route which is shifted back from the start point of the target downhill section by the pre-use distance Dp. In addition, the CPU 66 sets the end point of the target downhill section as the end point Pe of the downhill control. The set start point Ps and the set end point Pe are stored in the RAM 68. Subsequently, the CPU 66 proceeds to step 895 and ends the present routine.

Notably, in the case where no target downhill section is present, the CPU 66 makes a negative judgment (No) in step 815 and proceeds directly to step 895.

When the CPU 66 searches a target downhill section by the processing of step 810 of FIG. 8, the CPU 66 executes a “target downhill search processing routine” represented by the flowchart of FIG. 9. When the CPU 66 has succeeded in searching a target downhill section, the CPU 66 ends the present routine (the routine of FIG. 9) at that point in time and proceeds to step 815. Also, when the CPU 66 finds that no target downhill section is contained in the planned travel route, the CPU 66 ends the present routine and proceeds to step 815.

More specifically, when the CPU 66 executes the present routine, the CPU 66 investigates each of searched links which are obtained by extracting links, in the order in which the vehicle 10 travels through the links, the links being located forward of a point on the planned travel route which is separated from the present position Pn by the pre-use distance Dp. When the CPU 66 finds that a certain link is the end link of the target downhill section, the CPU 66 ends the present routine at that point in time. When the CPU 66 cannot find a target downhill section even after it investigates the final link of the planned travel route, the CPU 66 ends the present routine at that point in time.

For such an operation, the CPU 66 sets a variable i which represents a link (investigated link) which is investigated at that point in time. The CPU 66 sets the value of the variable i to “1” when it starts the present routine. The CPU 66 increases the value of the variable i by “1” every time the next link (an adjacent link more remote from the vehicle 10) becomes the investigated link. The CPU 66 ends the present routine if the CPU 66 cannot find a target downhill section even after the value of the variable i becomes a value corresponding to the last link of the planned travel route.

In the following description, a link corresponding to the value of the variable i (i.e., the i-th searched link) will also be referred to as the “i-th link” for simplicity. In addition, “link number” is used in order to specify the investigated link in the present routine. For example, the link number of a link which is investigated third in the present routine is “3.” In addition, in the present routine, a section which is possibly a target downhill section will be also referred to as a “candidate section.”

During execution of the present routine, the CPU 66 sets the link number of the start link (a link closest to the vehicle 10) of a candidate section at that point in time as the value of a candidate section start link Lsta, and sets the link number of the end link (a link farthest from the vehicle 10) of the candidate section at that point in time as the value of a candidate section end link Lend. When the value of the candidate section start link Lsta is “0,” it means that any candidate section is not present (is not found) at that point in time.

When a candidate section is present, the CPU 66 sets the “distance of the candidate section at that point in time” as the value of a candidate section total distance Dsum, and sets the “height difference between the start point and end point of the candidate section at that point in time” as the value of a candidate section total height difference Hsum. In the case where the end point of the candidate section is lower than the start point of the candidate section, the value of the candidate section total height difference Hsum becomes negative (i.e., Hsum<0).

In the case where the candidate section contains a flat link (flat section), the CPU 66 sets the “link number of the first link of the flat section” as the value of a flat section start link Fsta, and sets the “length of the flat section at that point in time” as the value of a flat section total distance dsum.

In the case where the candidate section satisfies the above-described target downhill section conditions, the CPU 66 sets a target downhill section extraction flag Xslp to “1.” In the case where the candidate section end link at this point in time is not the end link of the planned travel route, the CPU 66 judges whether or not the target downhill section conditions are satisfied even when the next link is added to the candidate section.

In the case where the value of the target downhill section extraction flag Xslp has already been set to “1” when the flat section total distance dsum becomes greater than the distance threshold Dth2, the CPU 66 extracts, as a target downhill section, a “section of the candidate section at that point in time which is located before the flat section start link Fsta.” In the case where the value of the target downhill section extraction flag Xslp is “0” when the flat section total distance dsum becomes greater than the distance threshold Dth2, the CPU 66 sets the value of the candidate section start link Lsta to “0” and starts searching of a new candidate section.

When a proper timing comes, the CPU 66 starts the processing from step 900 of FIG. 9 and proceeds to step 902 so as to execute initialization processing. More specifically, the CPU 66 obtains searched links by extracting links, in the order in which the vehicle 10 travels through the links, the links being located forward of a point on the planned travel route which is separated from the present position Pn by the pre-use distance Dp. Further, the CPU 66 sets the value of the variable i to “1.”

In addition, the CPU 66 sets the values of the candidate section total distance Dsum, the candidate section total height difference Hsum, the flat section total distance dsum, the flat section start link Fsta, the candidate section start link Lsta, the candidate section end link Lend, and the target downhill section extraction flag Xslp to “0.”

(Case 1) Case where Downhill Section Contains Flat Link

This case will be described with reference to an example shown in (B) of FIG. 4. In this case, after the processing of step 902, the CPU 66 proceeds to step 905 and judges whether or not the average gradient Gr(i) of the i-th link is less than the gradient threshold degth (namely, whether or not this link is a downward gradient link).

When step 905 is executed for the first time, since the variable i is “1,” CPU 66 judges whether or not link b1 of FIG. 4 (B) is a downward gradient link. As described above, since link b1 is a flat link (specifically, an uphill section), the CPU 66 makes a negative judgment (No) in step 905 and proceeds to step 955.

In step 955, the CPU 66 judges whether or not the value of the flat section start link Fsta is “0.” When step 955 is executed for the first time, since the flat section start link Fsta is “0”, the CPU 66 makes an affirmative judgment (Yes) in step 955 and proceeds to step 960 so as to set the value of the flat section start link Fsta to the value of the variable i (in this case, “1”).

Subsequently, the CPU 66 proceeds to step 965 and adds the length L(i) of the i-th link to the value of the flat section total distance dsum. In addition, the CPU 66 adds the length L(i) of the i-th link to the candidate section total distance Dsum and adds the height difference ΔH(i) of the i-th link to the candidate section total height difference Hsum.

Subsequently, the CPU 66 proceeds to step 970 and judges whether or not the flat section total distance dsum is greater than the distance threshold Dth2 or the candidate section total height difference Hsum is greater than “0.” When the flat section total distance dsum is greater than the distance threshold Dth2, it turns out that the condition (e) of the target downhill section conditions is not satisfied.

Meanwhile, when the candidate section total height difference Hsum is greater than “0”, the height of the end point of the candidate section is higher than the height of the start point of the candidate section at this point in time. Namely, the candidate section is an uphill section. Accordingly, when at least one condition of these two conditions is satisfied, the candidate section is reset at this time.

As described above, since link b1 is an uphill section, the height difference ΔH(1) is greater than “0” (namely, ΔH(1)>0). Accordingly, since the candidate section total height difference Hsum (=ΔH(1)) is greater than “0” at this point in time, the CPU 66 makes an affirmative judgment (Yes) in step 970 and proceeds to step 975 so as to judge whether or not the value of the target downhill section extraction flag Xslp is “1.”

Since the value of the target downhill section extraction flag Xslp “0” at the present, the CPU 66 makes a negative judgment (No) in step 975 and proceeds to step 985 so as to judge whether or not the value of the candidate section start link Lsta is greater than “0.” Since the value of the candidate section start link Lsta is “0” at the present, the CPU 66 makes a negative judgment (No) in step 985, proceeds to step 935, and adds “1” to the value of the variable i.

Subsequently, the CPU 66 proceeds to step 940 and judges whether or not the value of the variable i is greater than the total number of the links which constitute a searched link (in the present example, the CPU 66 judges whether or not the value of the variable i is greater than “10”). Since the value of the variable i is “2” at the present, the value of the variable i is smaller than the total number of the links. Accordingly, the CPU 66 makes a negative judgment (No) in step 940 and proceeds to step 905.

When the CPU 66 executes step 905 for the second time (namely, when the value of the variable i is “2”), since the average gradient Gr(2) of the second link (namely, link b2) is greater than the gradient threshold degth, the CPU 66 makes a negative judgment (No) in step 905 and proceeds to step 955. Since the flat section start link Fsta is set to “1”, the CPU 66 makes a negative judgment (No) in step 955 and proceeds directly to step 965.

In step 965, the flat section total distance dsum becomes the sum of the length of link b1 and the length of link b2 (that is, the distance from point Pb1 to point Pb3), and then the flat section total distance dsum becomes greater than the distance threshold Dth2. Accordingly, since the flat section total distance dsum is greater than the distance threshold Dth2, the CPU 66 makes an affirmative judgment (Yes) in step 970, executes the processings of step 975, step 985 and step 935 to step 940.

Subsequently, when the CPU 66 executes step 905 for the third time (namely, when the value of the variable i is “3”), since the average gradient Gr(3) of the third link (namely, link b3) is less than the gradient threshold degth, the CPU 66 makes an affirmative judgment (Yes) in step 905 and proceeds to step 910. In step 910, the CPU 66 judges whether or not the value of the candidate section start link Lsta is “0.” Since the value of the candidate section start link Lsta is “0” at the preset, the CPU 66 makes an affirmative judgment (Yes) in step 910 and proceeds to step 915.

In step 915, the CPU 66 sets the value of the candidate section start link Lsta to the value of the variable i (in this case, “3”). In addition, the CPU 66 sets the value of the candidate section total distance Dsum to “0” and sets the value of the candidate section total height difference Hsum to “0.”

Subsequently, the CPU 66 proceeds to step 920 and adds the length L(i) of the i-th link (the distance between the start point and end point of that link) to the candidate section total distance Dsum. In addition, the CPU 66 adds the height difference ΔH(i) of the i-th link to the candidate section total height difference Hsum. Further, the CPU 66 sets the value of the flat section total distance dsum to “0” and sets the value of the flat section start link Fsta to “0.”

Subsequently, the CPU 66 proceeds to step 925 and judges whether or not the following conditions are satisfied; (1) the candidate section total distance Dsum is greater than the distance threshold Dth1, and (2) the candidate section total height difference Hsum is negative and its absolute value is greater than the height difference threshold Hth. Since these conditions are not satisfied at the present point in time, the CPU 66 makes a negative judgment (No) in step 925 and proceeds to step 935. After that, the CPU 66 performs step 935 to step 940, and then proceeds to step 905.

When the CPU 66 executes step 905 for the fourth time and the fifth time, since both link b4 and link b5 are a downward gradient link, the CPU 66 makes an affirmative judgment (Yes) in step 905 and proceeds to step 910. Since the value of the candidate section start link Lsta is “3” at the present, the CPU 66 makes a negative judgment (No) in step 910 and proceeds directly to step 920.

Further, the CPU 66 performs the following processings. As a result, the candidate section total distance Dsum becomes the sum of the length of link b3 to link b5 and the candidate section total height difference Hsum become the sum of the height difference of link b3 to link b5. However, at this point in time, the candidate section total distance Dsum is less than the distance threshold Dth1 and the candidate section total height difference Hsum is less than the height difference threshold Hth.

When the CPU 66 executes step 905 for the sixth time (namely, when the value of the variable i is “6”), since link b6 is a flat link, the CPU 66 makes a negative judgment (No) in step 905 and performs step 955 to step 965, and then proceeds to step 970. The flat section total distance dsum is the distance Db6 of a section corresponding to link b6 at the present. In addition, the candidate section total height difference Hsum is the height difference between point Pb3 and point Pb7 and less than “0.” Accordingly, the CPU 66 makes a negative judgment (No) in step 970 and proceeds directly to step 935.

After that, when the CPU 66 executes step 905 for the eighth time (namely, when the value of the variable i is “8”), since link b8 is a downward gradient link, the CPU 66 makes an affirmative judgment (Yes) in step 905 and proceeds to step 925 via step 910 and step 920. At the present, the candidate section total distance Dsum is greater than the distance threshold Dth1 and the candidate section total height difference Hsum is greater than the height difference threshold Hth.

Accordingly, the CPU 66 makes an affirmative judgment (Yes) in step 925 and proceeds to step 930 so as to set the value of the target downhill section extraction flag Xslp to “1.” Subsequently, the CPU 66 proceeds to step 905 via step 935 to step 940.

After that, when the CPU 66 executes step 905 for the ninth time (namely, when the value of the variable i is “9”), since link b9 is a flat link, the CPU 66 makes a negative judgment (No) in step 905 and proceeds to step 955. Subsequently, the CPU 66 makes an affirmative judgment (Yes) in step 955 and proceeds to step 960 so as to set the value of the flat section start link Fsta to the value of the variable i (in this case, “9”).

Subsequently, the CPU 66 performs step 965 and the flat section total distance dsum becomes the length of the link b9 (the distance Db9). The flat section total distance dsum is less than the distance threshold Dth2 at the present. Accordingly, the CPU 66 makes a negative judgment (No) in step 970 which is the step to be performed and proceeds to step 935.

Further, when the CPU 66 executes step 905 for the tenth time (namely, when the value of the variable i is “10”), since link b10 is a flat link, the CPU 66 makes a negative judgment (No) in step 955. The CPU 66 proceeds from step 955 to step 965, and then the flat section total distance dsum is equal to the “sum of the length of link b9 (the distance Db9) and the length of link b10 (the distance Db10)” and becomes greater than the distance threshold Dth2.

Accordingly, the CPU 66 makes an affirmative judgment (Yes) in step 970 and proceeds to step 975. Since the value of the target downhill section extraction flag Xslp is “1” at this point, the CPU 66 makes an affirmative judgment (Yes) in step 975 and proceeds to step 980. In step 980, the CPU 66 sets the value of the candidate section end link Lend to a value which is smaller than the value of the flat section start link Fsta (in this case, “9”) by “1.” Namely, the candidate section end link Lend becomes “8.”

Subsequently, the CPU 66 proceeds to step 995 and ends the present routine. When the present routine ends, there has been created a state in which the value of the target downhill section extraction flag Xslp is “1,” the candidate section start link Lsta is “3,” and the candidate section end link Lend is “8.” In other words, as a result of execution of the present routine, link b3 to link b8 have been extracted as a target downhill section.

(Case 2) Case where End Link of Planned Travel Route is the Same as End Link of Target Downhill Section

Next, this case will be described with reference to an example shown in (A) of FIG. 4. In this case, when the CPU 66 executes step 905 for the ninth time (namely, when the value of the variable i is “9”), the CPU 66 makes an affirmative judgment (Yes) in step 905 and proceeds to step 910 and then to step 920.

After execution of the processing of step 920, the candidate section total distance Dsum (namely, the distance from point Pa5 to point Pa10) is greater than the distance threshold Dth1. In addition, the candidate section total height difference Hsum (namely, the difference between the height of point Pa5 and the height of point Pa11) is negative and its absolute value is greater than the height difference threshold Hth. Accordingly, the CPU 66 makes an affirmative judgment (Yes) in step 925 and proceeds to step 930 so as to set the value of the target downhill section extraction flag Xslp to “1.”

After that, when the CPU 66 executes step 905 for the tenth time (namely, when the value of the variable i is “10”), the CPU 66 makes an affirmative judgment (Yes) in step 905, executes the processings of step 910 and step 920 to step 935, and proceeds to step 940.

At this time, since the value of the variable i is “11,” the CPU 66 makes an affirmative judgment (Yes) in step 940 and proceeds to step 945 so as to judge whether or not the target downhill section extraction flag Xslp is “1” and the value of the candidate section end link Lend is “0.”

At this point in time, the target downhill section extraction flag Xslp is “1” and the value of the candidate section end link Lend is “0.” Therefore, the CPU 66 makes an affirmative judgment (Yes) in step 945 and proceeds to step 950. In step 950, the CPU 66 sets the value of the candidate section end link Lend to a value which is smaller by “1” than the value of the variable i (in this case, Lend=10). Subsequently, the CPU 66 proceeds to step 995.

Accordingly, in the present example, when the present routine ends, there has been created a state in which the value of the target downhill section extraction flag Xslp is “1,” the candidate section start link Lsta is “5,” and the candidate section end link Lend is “10.” In other words, as a result of execution of the present routine, link a5 to link a10 have been extracted as a target downhill section.

(Case 3) Case where Downhill Section Contains Continuous Flat Link

This case will be described with reference to an example shown in (C) of FIG. 4. In this case, link c1 is a downward gradient link. Therefore, when the CPU 66 executes step 905 for the first time, the CPU 66 makes an affirmative judgment (Yes) in each of step 905 and step 910 and proceeds to step 915 so as to set the value of the candidate section start link Lsta to “1.” Further, the CPU 66 sets the value of the candidate section total distance Dsum to “0” and sets the value of the candidate section total height difference Hsum to “0.”

After that, when the CPU 66 executes step 905 for the fourth time (namely, when the value of the variable i is “4”), since link c4 is a flat link, the CPU 66 makes a negative judgment (No) in step 905 and proceeds to step 955. Subsequently, the CPU 66 makes an affirmative judgment (Yes) in step 955 and proceeds to step 960 so as to set the value of the flat section start link Fsta to “4.”

Further, when the CPU 66 executes step 905 for the fifth time (namely, when the value of the variable i is “5”), the CPU 66 makes a negative judgment (No) in step 905 and proceeds to step 955. After that, When the CPU 66 performs step 965, the flat section total distance dsum is equal to the “sum of the length of link c4 (the distance Dc4) and the length of link c5 (the distance Dc5)” and becomes greater than the distance threshold Dth2. Accordingly, the CPU 66 makes an affirmative judgment (Yes) in step 970 and proceeds to step 975. Subsequently, the CPU 66 makes a negative judgment (No) in step 975 and proceeds to step 985.

In step 985, the CPU 66 judges whether or not the value of the candidate section start link Lsta is greater than “0.” At this point in time, since the value of the candidate section start link Lsta is “1”, the CPU 66 makes an affirmative judgment (Yes) in step 985 and proceeds to step 990. In step 990, the CPU 66 sets the value of the candidate section start link Lsta to “0.” Subsequently, the CPU 66 proceeds to step 935.

After that, when the CPU 66 executes step 905 for the tenth time (namely, when the value of the variable i is “10”), the CPU 66 proceeds to step 945 via step 920 to step 925, step 935 to step 940.

At this point in time, since the value of the target downhill section extraction flag Xslp is “0” (the value of the candidate section end link Lend is “0”), the CPU 66 makes a negative judgment (No) in step 945 and proceeds directly to step 995.

(Specific Operation—Execution of Downhill Control by Travel Assisting Apparatus)

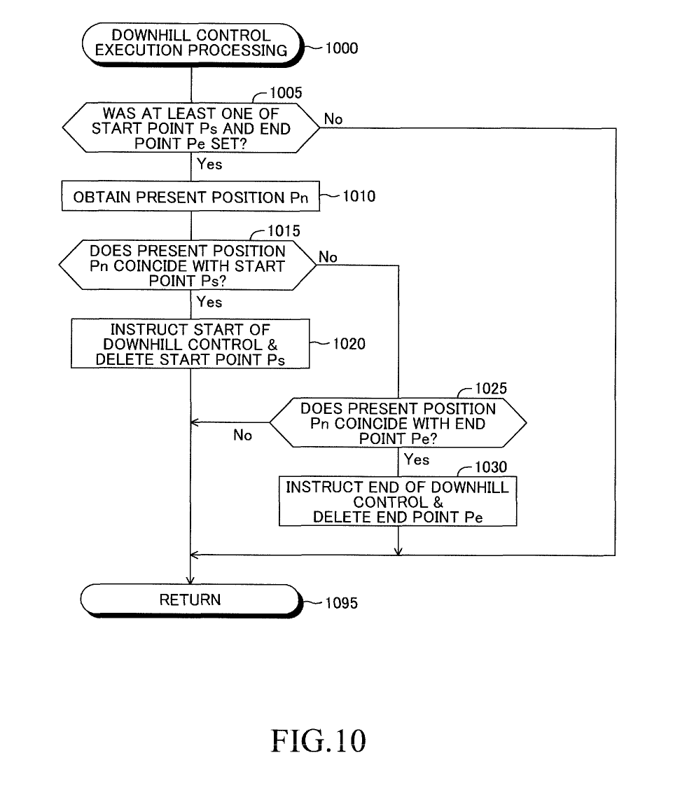

In order to execute the downhill control, the CPU 66 executes a “downhill control execution processing routine” represented by the flowchart of FIG. 10 every time a predetermined period of time elapses. Accordingly, when a proper timing comes, the CPU 66 starts the processing from step 1000 of FIG. 10 and proceeds to step 1005 so as to judge whether or not at least one of the start point Ps and end point Pe of the downhill control section has been set.

In the case where at least one of the start point Ps and end point Pe has been set, the CPU 66 makes an affirmative judgment (Yes) in step 1005 and proceeds to step 1010. In step 1010, the CPU 66 obtains the present position Pn which is obtained by the GPS receiving section 62. Subsequently, the CPU 66 proceeds to step 1015 and judges whether or not the present position Pn coincides with the start point Ps.

In the case where the present position Pn coincides with the start point Ps (in actuarially, falls with a range of “the start point Ps−several tens of meters” to “the start point Ps+several tens of meters”), the CPU 66 makes an affirmative judgment (Yes) in step 1015 and proceeds to step 1020 so as to instruct the ECU 40 to start the downhill control. The ECU 40 having received the instruction changes the target remaining capacity SOC* from the standard remaining capacity Sn to the low-side remaining capacity Sd by executing an unillustrated routine. Further, the CPU 66 deletes the data of the start point Ps. Subsequently, the CPU 66 proceeds to step 1095 and ends the present routine temporarily.

Meanwhile, in the case where the present position Pn does not coincide with the start point Ps (including the case where the start point Ps has been deleted), the CPU 66 makes a negative judgment (No) in step 1015 and proceeds to step 1025 so as to judge whether or not the present position Pn coincides with the end point Pe.

In the case where the present position Pn coincides with the end point Pe, the CPU 66 makes an affirmative judgment (Yes) in step 1025 and proceeds to step 1030 so as to instruct the ECU 40 to end the downhill control. The ECU 40 having received the instruction changes the target remaining capacity SOC* from the low-side remaining capacity Sd to the standard remaining capacity Sn by executing an unillustrated routine. Further, the CPU 66 deletes the data of the end point Pe. Subsequently, the CPU 66 proceeds to step 1095.

In the case where none of the start point Ps and the end point Pe has been set, the CPU 66 makes a negative judgment (No) in step 1005 and proceeds directly to step 1095. In addition, in the case where the present position Pn does not coincide with the end point Pe, the CPU 66 makes a negative judgment (No) in step 1025 and proceeds directly to step 1095.

As described above, the present control apparatus (the ECU 40 and the travel assisting apparatus 60) is a hybrid vehicle control apparatus applied to a hybrid vehicle (10) which includes an internal combustion engine (23) and a motor (the first motor 21 and the second motor 22) as drive sources of the vehicle, includes a storage battery (31) for supplying electric power to the motor, and is configured to perform regenerative braking by using the motor, and charge the storage battery with electric power generated as a result of the regenerative braking and electric power generated by using output of the internal combustion engine,

the hybrid vehicle control apparatus comprising a controller which controls the internal combustion engine and the motor in such a manner that a demanded drive force (the demanded ring gear torque Tr*) for the vehicle is satisfied and the remaining capacity (SOC) of the storage battery approaches a predetermined target remaining capacity (SOC*, the standard remaining capacity Sn).

wherein the controller comprises:

a downhill determination portion which obtains information concerning a plurality of links representing a planned travel route of the vehicle and determines whether or not a target downhill section which satisfies a predetermined condition is contained in the planned travel route on the basis of the obtained information (step 815 of FIG. 8 and FIG. 9); and

a downhill control portion which executes downhill control in the case where the downhill determination portion determines the target downhill section is contained when the vehicle travels in a particular section of a section which extends to the end point (Pe) of the target downhill section from a downhill control start point (Ps) which is shifted back from the start point of the target downhill section by a predetermined first distance (the pre-use distance Dp), the particular section containing at least a section extending from the downhill control start point to the start point of the target downhill section, the downhill control changing the target remaining capacity to a remaining capacity smaller as compared with the case where the vehicle travels in sections other than the particular section (the low-side remaining capacity Sd),

the downhill determination portion determining a section represented by a set of links which are continuous links and contained in the obtained plurality of links is a target downhill section, when the set of links satisfies all of conditions, where

a section corresponding to a start link which is the closest to the vehicle among the set of links is a downhill in which the gradient is greater than a gradient represented by a predetermined gradient threshold (degth),

the height of the end point is lower than the height of the start point,

the height difference between the start point and the end point is greater than a predetermined height difference threshold (Hth), and

a section which corresponds to a link or continuous links, in which the gradient isn't greater than a gradient represented by the gradient threshold and whose distance is greater than a predetermined second distance (the distance threshold Dth2) isn't contained between the start point and the end point,

are satisfied.

Accordingly, the present control apparatus can extract the target downhill section properly to thereby increase the remaining capacity SOC by the downhill control and improve the fuel efficiency of the vehicle.

Although the embodiment of the hybrid vehicle control apparatus according to the present invention have been described, the present invention is not limited to the above-described embodiments and may be changed in various ways without departing from the scope of the present invention. For example, the travel assisting apparatus in the present embodiment receives signals from GPS satellites. However, the travel assisting apparatus may receive other satellite positioning signals in place of or in addition to the GPS signals. For example, the other satellite positioning signals may be GLONASS (Global Navigation Satellite System) and QZSS (Quasi-Zenith Satellite System).

In the case where the downhill control is executed in the present embodiment, the target remaining capacity SOC* is changed from the low-side remaining capacity Sd to the standard remaining capacity Sn when the vehicle 10 reaches the end point of each target downhill section. However, in the case where the downhill control is executed, the target remaining capacity SOC* may be changed from the low-side remaining capacity Sd to the standard remaining capacity Sn when the vehicle 10 reaches the start point of each target downhill section. Alternatively, in the case where the downhill control is executed, the target remaining capacity SOC* may be changed from the low-side remaining capacity Sd to the standard remaining capacity Sn when the vehicle 10 is located midway in each target downhill section.

In the present embodiment, when the travel assisting apparatus extracts a target downhill section, the travel assisting apparatus performs the extracting operation for a route extending to the destination from a point on the planned travel route which is separated from the present position Pn by the pre-use distance Dp. However, the travel assisting apparatus may perform the extracting operation for a route extending from the present position Pn on the planned travel route to the destination.

Alternatively, the travel assisting apparatus of each embodiment may perform the extraction operation as follows. When the travel assisting apparatus extracts a target downhill section, the travel assisting apparatus performs the extracting operation for a route extending from the “present position Pn” to a “position which is locate at a predetermined distance (e.g., 5 km) from the present position Pn on the planned travel route.” In this case, irrespective of whether the downhill control is executed, the travel assisting apparatus may execute the target downhill section extraction processing periodically (e.g., at intervals of 5 minutes) or every time the vehicle 10 travels over a predetermined distance.

In the present embodiment, when the vehicle 10 has reached the start point Ps of a downhill control section or the end point Pe thereof, the travel assisting apparatus notifies the ECU 40 of the fact that the vehicle 10 has reached the start point Ps or the end point Pe. However, when the travel assisting apparatus decides to execute the downhill control, the travel assisting apparatus may notify the ECU 40 of the distance from the present position Pn to the start point Ps and the distance from the present position Pn to the end point Pe. In this case, the ECU 40 may obtain the distances from the present position Pn at that point in time to the start point Ps and the end point Pe on the basis of the travel distance of the vehicle 10 obtained by integrating the vehicle speed Vs with respect to time, and change the value of the target remaining capacity SOC* when the vehicle 10 reaches the start point Ps or the end point Pe.

The map database in the present embodiment contains the length and gradient of each link. However, the map database may contain the heights of opposite ends of each link instead of the gradient of each link.

In the present embodiment, the travel assisting apparatus judges that a downhill section satisfying the above-described target downhill condition sets (conditions (a), (b), (c), (d) and (e)) is a target downhill section. However, the condition (b) may be omitted. In this case, even when the distance from the start point to the end point of a downhill section is not long, if the height difference between the start point and the end point of the downhill section is greater than the height difference threshold Hth, the downhill section is judged to be a target downhill section.

For example, in case that a planned travel route contains a tunnel and gradient information of links is based on the height of the ground above the tunnel instead of the height of the ground of roads in the tunnel, the height difference between a point of the road in the tunnel and a point of a road after the vehicle went through the tunnel may be excessive. Namely, in this case, although the distance from the start point and the end point of a downhill section is short, the height difference between the start point and the end point may be huge. In other words, the downhill section which does not satisfy the target downhill section conditions may be judged to be a target downhill section because of accidental errors of the gradient information of links. In view of this, the distance threshold Dth1 may be configured so as to avoid this kind of an erroneous decision. Alternatively, as described above, the above-described condition (b) may be omitted.

The map database in the present embodiment is constituted by a hard disk drive. However, the map database may be constituted by a solid state drive (SSD) using a recording medium such as flash memory or the like.

What is claimed is:

1. A hybrid vehicle control apparatus applied to a hybrid vehicle which includes an internal combustion engine and a motor as drive sources of said vehicle, includes a storage battery for supplying electric power to said motor, and is configured to perform regenerative braking by using said motor, and charge said storage battery with electric power generated as a result of said regenerative braking and electric power generated by using output of said internal combustion engine,
said hybrid vehicle control apparatus comprising a controller which controls said internal combustion engine and said motor in such a manner that a demanded drive force for said vehicle is satisfied and the remaining capacity of said storage battery approaches a predetermined target remaining capacity.
wherein said controller comprises:
a downhill determination portion which obtains information concerning a plurality of links representing a planned travel route of said vehicle and determines whether or not a target downhill section which satisfies a predetermined condition is contained in said planned travel route on the basis of said obtained information; and
a downhill control portion which executes downhill control in the case where said downhill determination portion determines said target downhill section is contained when said vehicle travels in a particular section of a section which extends to the end point of said target downhill section from a downhill control start point which is shifted back from the start point of said target downhill section by a predetermined first distance, said particular section containing at least a section extending from said downhill control start point to the start point of said target downhill section, said downhill control changing said target remaining capacity to a remaining capacity smaller as compared with the case where said vehicle travels in sections other than said particular section,
said downhill determination portion determining a section represented by a set of links which are continuous links and contained in said obtained plurality of links is a target downhill section, when said set of links satisfies all of conditions, where
a section corresponding to a start link which is the closest to said vehicle among said set of links is a downhill in which the gradient is greater than a gradient represented by a predetermined gradient threshold,
the height of the end point is lower than the height of the start point,
the height difference between the start point and the end point is greater than a predetermined height difference threshold, and
a section which corresponds to a link or continuous links, in which the gradient isn't greater than a gradient represented by the gradient threshold and whose distance is greater than a predetermined second distance isn't contained between the start point and the end point, are satisfied.
